(19) United States
(12) Patent Application Publication
(10) Pub. No.: US 2015/0022326 A1
(43) Pub. Date: Jan. 22, 2015

(54) System for Measuring and Reporting a Condition of Equipment

(71) Applicant: Cameron International Corporation, Houston, TX (US)

(72) Inventors: Daniel B. Baxter, Houston, TX (US); John C. Bartos, Houston, TX (US); Everette Johnson, Houston, TX (US); Edward E. Roper, Houston, TX (US); Jack Dowling, Allen, TX (US)

(21) Appl. No.: 13/946,676

(22) Filed: Jul. 19, 2013

(51) Int. Cl. G06K 19/07; G06K 7/00

(52) U.S. Cl. CPC G06K 19/0723; G06K 7/0008
USPC 340/10.6; 340/10.1

(57) ABSTRACT

A system for measuring and reporting conditions of equipment comprises a sensor to measure a condition of the equipment. The sensor communicates with a processor in communication that receives the signal from the sensor and converts the signal to data. A data storage device in communication with the processor stores the measurement data. Also included is a wireless communication interface in communication with the processor for wireless communicating the measurement data.

### BACKGROUND

To meet the demand for natural resources, companies often invest significant amounts of time and money in searching for and extracting oil, natural gas, and other subterranean resources from the earth. Particularly, once a desired resource is discovered below the surface of the earth, drilling and production systems are often employed to access and extract the resource. These systems may be located onshore or offshore depending on the location of a desired resource. Further, such systems generally include a completion system that includes wellhead assembly through which the resource is extracted. These completion systems for oil and gas wells may include a wide variety of components, such as various casings, hangers, valves, fluid conduits, trees, valves, etc. Additionally, other equipment, such as pipes, valves, and fittings are used in transporting the resources from one location to another.

Normally, it is difficult to know the conditions a piece of equipment has experienced over time without monitoring its operating conditions. For example, in determining the condition of a valve, it is useful to know of the valve has been taken beyond the design specifications. Design specifications of concern can include pressure, temperature, corrosion, vibration, cycle count, etc. The atmosphere can also make it difficult or dangerous to monitor equipment. In such a dangerous environment, it can be beneficial to improve safety and render a fast response or reaction of the equipment condition without interruption of the working process. While monitoring a parameter or condition, a deviation from design specifications can be indicative of a developing failure.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is an illustrative working environment wherein a system for measuring and reporting conditions of equipment could operate; and

FIG. 2 is an illustrative embodiment of an alternative embodiment of a system for measuring and reporting conditions of equipment.

### DETAILED DESCRIPTION OF SPECIFIC EMBODIMENTS

The following discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

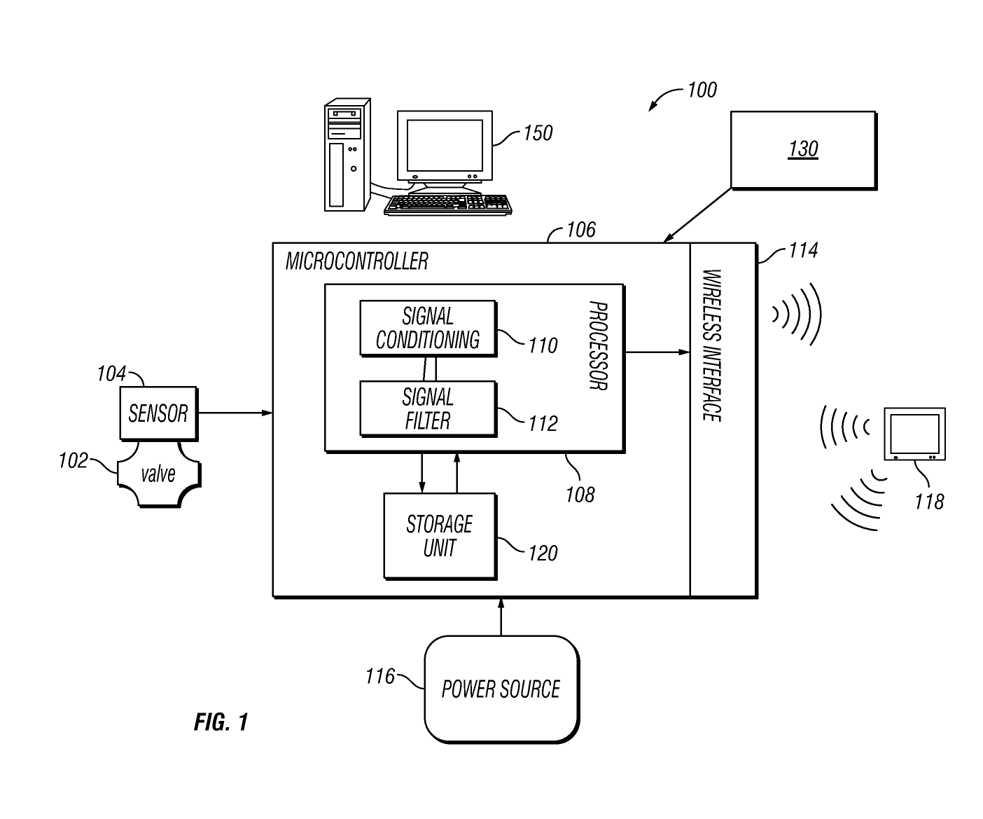

To further assist the reader's understanding of the disclosed systems and methods, an environment for their use and operation is described. Referring now to FIG. 1, a system 100 for measuring and reporting conditions of equipment is disclosed. As an example for this embodiment, the equipment being monitored is a valve 102. However, it should be appreciated that the equipment being monitored can be any type of equipment used in drilling or producing oil and gas wells or for transporting or treating oil and gas. For example, the condition monitoring and reporting device 100 can be attached to other equipment such as process equipment, manifolds, blow-out preventers, compressors, and any other pressure vessel.

The system 100 includes a sensor 104 to measure a condition of the valve 102. For example, the condition monitored may include one or more of strain, temperature, pressure, valve position (current position and stroke count), impact, or any other operating or environmental parameter. The sensor 104 may be attached, connected to, or otherwise in communication with the equipment 102 so as to measure the condition of the equipment. In the case of strain, for example, the sensor 104 would contact the surface of the equipment 102 so that strain could be measured without any hysteresis due to mechanical slippage. As shown in this embodiment, the sensor 104 is mounted directly to the valve 102. Additionally, the sensor 104 could be temperature compensated to correct for measurement discrepancies due to environmental conditions. It should be appreciated that more than one sensor 104 may also be included for measuring conditions of the same or different pieces of equipment.

The system 100 also includes a microcontroller 106 in communication with the sensor 104 in a modular scheme. The microcontroller 106 includes a processor 108 and a data storage device 120. While described as part of a microcontroller, it should be appreciated that the processor 108 and the data storage device 120 may be separate components. Additionally, the processor 108 may also be a logic circuit. The signal from the sensor 104 is transmitted to the microcontroller 106, which operates using software or firmware to convert the signal to measurement data for storage in the data storage device 120. The microcontroller 106 may also perform other tasks for the system 100 as described below. In the embodiment shown, the processor 108 is capable of performing multiple functions with the signal received from the sensor 104. For example, the processor 108 may include signal conditioning circuitry 110 to condition the sensor signal. As an example, the signal may be conditioned by isolators and amplifiers. The processor 108 may also include signal filtering circuitry 112 to filter the sensor signal. As an example, the signal may be filtered by hardware and software filters in and around the microcontroller.

The microcontroller 106 may also include intelligence to determine if a sensor measurement is outside of a threshold value set for a particular sensor 104. The threshold can be set ahead of time and may also be updated. The microcontroller 106 may also be designed for specific control functions as described within the larger system, often with real-time computing constraints. The microcontroller 106 may also have minimal requirements for memory and program length, and low firmware/software complexity. The microcontroller 106 may also provide real-time data response to events in the overall system and method. It should also be appreciated that while a microcontroller is used in this embodiment, the processor 108 and the data storage device 120 may be separate components and, in some embodiments, the data storage device 120 may instead be integral with a wireless communication interface as described below.

The data storage device 120 stores measurement data from the processor 108 as well as other data such as information relating to a breech of a measurement threshold value and records of communications with the system 100 through a wireless communication interface 114 described below. The data storage device 120 can be of any type of storage medium, such as a flash memory based drive, radio-frequency identification (RFID) tag, or other solid state persistent memory. Additionally, data storage device 120 may be integral with a wireless communication interface 114 described below.

The system 100 also includes a wireless communication interface 114 in communication with the microcontroller 106. The wireless interface 114 may communicate data from the processor 108 or the data storage device 120 and may use any suitable wireless communication protocol. As an example, the wireless interface 114 includes a radio-frequency identification (RFID) tag and communicates using radio waves. The wireless interface 114 may also communicate using Bluetooth, Wi-Fi, RF signals, satellite communications, and the like. In operation, the wireless interface 114 communicates measurement data from the sensor 104, including current and past measurements as well as whether the equipment condition was operating outside of a threshold value. The wireless interface 114 can also relay a collection of stored data from the data storage device 120. One embodiment of the wireless interface 114 may include the processor 108 writing a data to an RFID tag (or a register that in electronic communication with both the microcontroller 106 and the RFID tag). In this case, the RFID tag operates as a wireless interface 114 as well as a data storage device 120. The wireless interface 114 may also be used to receive information or commands such as to update the software/firmware of the microcontroller 116. For example, the wireless interface 114 may be used to update the system 100 with a new threshold parameter for the equipment.

The system 100 also includes a power source 116 to power the microcontroller 106 and the wireless interface 114. The power source 116 may be any power source suitable for powering the system 100, including for example a rechargeable power source, a battery, or a power source powered by renewable energy such as solar, wind, or wave power. If rechargeable, the power source 116 can be charged any energy harvesting method such as RF energy from a portable computer or transceiver 118, thermal differential energy, solar energy, wind energy, vibration energy, wave energy, or any other suitable method. Optionally, the battery health can also be reported through the wireless interface 314.

The power source 116 could be robust and capable of enduring long-term exposure to hostile environments. Although the system 100 may require little power, its application is not limited by the reliance on battery power. Harvesting energy from other sources could enable smart sensors to be functional indefinitely. Further, because the system 100 can require very little power, energy can also be stored in a capacitor. Capacitors can be used when the application needs to provide huge energy spikes.

The system 100 may optionally include a visual indicator 130 to display a condition of the equipment. The software or firmware used for operating the processor may also be used to control the visual indicator 130 based on the sensor measurements. For example, the visual indicator 130 (such as green, yellow or red lights) could indicate that a piece of equipment has exceeded a threshold design parameter. The visual indicator 130 can also be displayed via a display unit associated with the system 100.

The system 100 may also include a computer 150 to process and store data relating to the measurements gathered by the sensor 104. The computer 150 can also include a display mechanism for an operator or other individual to monitor the status of the equipment. To communicate with the sensor 104, the computer 150 may include a corresponding wireless communication interface that can communicate with the wireless interface 114 using any of the communication methods described above. The computer 150 may communicate by both receiving data as well as sending information to the processor 108 or the data storage device 120. For example, the computer 150 may update the software or firmware of the processor 108 or update data stored in the data storage device 120. Additionally, a visual display of the measurement data of either current or past measurements may also be displayed via a display unit associated with the computer 150.

The system 100 may also include a portable computer 118, such as a tablet or laptop computer as well as an RFID reader/writer. The portable computer likewise may include a corresponding wireless communication interface that can communicate with the wireless interface 114 using any of the communication methods described above. The portable computer 118 may communicate by both receiving data as well as sending information to the processor 108 or the data storage device 120. For example, the wireless interface 114 may include an RFID tag and the portable computer 118 may be an RFID reader/writer that may update the information stored on the RFID tag. Additionally, a visual display of the measurement data of either current or past measurements may also be displayed via a display unit associated with the portable computer 118.

As an example method for the use of the system 100, the sensor or sensors 104 are installed for measuring at least one condition of a piece or pieces of equipment and communicating the measurements to a processor or control logic circuit in the form of a signal. The condition of the equipment being measured may include at least one of temperature, valve position, strain, and impact. The processor may also be programmed with a threshold value for the condition being measured that may be set at any desired value and may also be updated at any time. The processor operates using software or firmware to process the signal from the sensor and convert the signal into data. At a later time, the software or firmware may also be updated with a direct communication connection or wirelessly using the wireless communication described below. The processor may also perform signal conditioning and filtering on the measurement signal. The condition being measured may be any condition, such as strain, temperature, valve position, impact, etc. The processor may also be used to determine if the measured data breeches a threshold value. The measurement data is stored in a data storage device for retrieval. The data storage device can be of any type of storage medium.

At the same or a later time, the measurement data is wirelessly communicated at least some of the measurement data using any suitable wireless communication system. As an example, the measurement data may be wirelessly communicated to a computer or to a portable computer such as a tablet computer or RFID reader/writer. Additional data may also be processed and communicated wirelessly. For example, data regarding a measurement crossing a threshold value may be communicated. As an example, a person may use an RFID reader to communicate with an RFID tag to retrieve measurement data. As another example, the measured condition of the equipment may also be displayed in real-time or at a later time using a display associated with the processor or a graphic display on a monitor of a computer system or portable computer system.

Additionally, the condition or previous condition of the equipment may be sent to and displayed by a visual indicator that may be, for example, a light indicator or a display on a computer or portable computer. As another example, the measured condition of the equipment may also be displayed in real-time or at a later time using the visual indicator. For example, the visual indicator may be a display associated with the processor.

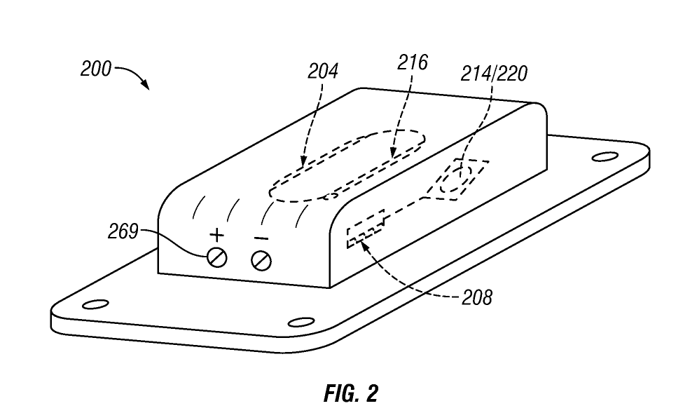

Referring now to FIG. 2, an alternative system 200 for measuring and reporting conditions of equipment is shown as a self-contained system with a processor 208 and a data storage device 220. It should be appreciated that the processor 208 and the data storage device 220 may also be integrated components arranged as a microcontroller. Additionally, the processor 208 may also be a logic circuit. The system 200 also includes a power source 216, sensor(s) 204, and a wireless interface 214 all enclosed within a housing 260 designed to be connected or attached directly to the equipment being monitored. In this particular embodiment, the sensor(s) 204 is attached or connected to the housing 260 in such a way as to measure the condition of the equipment when the housing 260 is attached or connected with the equipment. For example, the sensor 204 may be a strain gauge mounted directly to the outer surface of the equipment. As described above, the signal from the sensor(s) 204 is transmitted to the processor 208, which includes software/firmware to receive the signal and process the signal into measurement data for storage in the data storage device 220. The processor 208 may also perform signal conditioning and filtering as described above.

As an example, the sensor 204 of the system 200 shown in FIG. 2 may be a strain gauge and the wireless interface 114 may include an RFID tag that is also the data storage device 220. The system 200 may be powered by a rechargeable power source 216 and include inputs 269 for connecting the power source 216 to an electric current for recharging. The processor 208 processes and can also analyze the incoming signal from the strain gauge sensor 204. The measurement data can be transmitted via the RFID wireless interface 214. The system 200 may also include a visual indicator (not shown) as described above.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A system for measuring and reporting a condition of equipment, comprising:
a sensor to measure a condition of the equipment;
a processor in communication with the sensor capable of receiving a signal from the sensor and converting the signal to data;
a data storage device in communication with the processor and capable of storing the data;
a wireless communication interface in communication with the processor.

2. The system of claim 1, wherein the wireless communication interface includes a frequency identification (RFID) tag that also includes the data storage device.

3. The system of claim 2, wherein the RFID tag can communicate measurement data from the processor.

4. The system of claim 1, further comprising a power source.

5. The system of claim 1, further comprising a visual indicator to display a condition of the equipment.

6. The system of claim 5, wherein the visual indicator can visually indicate whether the data has crossed a threshold value.

7. The system of claim 1, wherein the condition of the equipment is one of strain, temperature, valve position, cycle count, vibration and impact.

8. The system of claim 1, wherein the processor and memory storage device are part of a microcontroller capable of performing one of signal conditioning and filtering of incoming measurements.

9. The system of claim 1, wherein the processor is programmed with a threshold value for the measurement data.

10. The system of claim 9, wherein the wireless interface is capable of updating the system with a new threshold parameter.

11. A method for reporting the condition of equipment, that comprises:
acquiring measurements of a condition of the equipment;
converting the measurements into data;
storing the measurement data in a data storage device; and
wirelessly communicating the measurement data.

12. The method of claim 11, further comprising visually displaying the condition of the equipment.

13. The method of claim 11, further comprising determining if the measurement data are beyond a threshold value.

14. The method of claim 13, further comprising visually indicating that the condition of the equipment has gone beyond the threshold value.

15. The method of claim 11, wherein processing the measurements includes signal conditioning and signal filtering.

16. The method of claim 11, further comprising:
a processor to convert the measurements into data that operates using software or firmware; and
updating the software or firmware of the processor.

17. The method of claim 11, wherein wirelessly communicating measurement data comprises communicating using radio frequency waves.

18. The method of claim 11, wherein the condition of the equipment includes at least one of strain, temperature, valve position, cycle count, vibration and impact.

19. The method of claim 11, further comprising wirelessly communicating the measurement data to at least one of a computer and a radio frequency identification reader (RFID) reader.

20. The method of claim 19, further comprising visually displaying information relating to the measured condition on the computer or RFID reader.
